(19) United States
(12) Patent Application Publication
(10) Pub. No.: US 2018/0196798 A1
(43) Pub. Date: Jul. 12, 2018

(54) SYSTEMS AND METHODS FOR CREATING CONCEPT MAPS USING CONCEPT GRAVITY MATRIX

(71) Applicant: Wipro Limited, Bangalore (IN)

(72) Inventors: Chetan Narasimha YADATI, Bangalore (IN); Surajit SEN, Bangalore (IN)

(73) Assignee: Wipro Limited

(21) Appl. No.: 15/441,277

(22) Filed: Feb. 24, 2017

(30) Foreign Application Priority Data
Jan. 6, 2017 (IN) 201741000658

(51) Int. Cl. G06F 17/27; G06F 17/16

(52) U.S. Cl. CPC G06F 17/2785; G06F 17/2715; G06F 17/16

(57) ABSTRACT

This disclosure relates to systems and method for creating concept maps using concept gravity matrix. The method includes extracting a plurality of n-grams from the text corpus; creating a gravity matrix based on a frequency of occurrence of each of the plurality of n-grams within the text corpus and word-distance amongst the plurality of n-grams; calculating a corpus gravity based on the gravity matrix; determining a concept gravity and a concept influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and creating the concept map based on the concept gravity and the concept influence determined for each of the plurality of n-grams.

### TECHNICAL FIELD

This disclosure relates generally to concept maps and more particularly to systems and methods for creating concept maps using concept gravity matrix.

### BACKGROUND

A detailed textual description of a forest, for example, would delve into various aspects of a forest. These aspects, for example, may include dense growth of trees, wild animals, and wilderness. While different textual descriptions of a forest would necessarily include the essential concepts that define a forest, however, other additional and non-essential details would vary from one textual description to the other. The non-essential details, for example, may include presence of streams or presence of particular type of wild animals.

However, a mere textual description on its own does not provide a structured information that indicates the important concepts in the textual description. Such important concepts in crux is displayed using concept maps that depicts these important concepts present in a text corpus in a graphical way. The strength of the connections between various concepts is depicted by the size of the arrows connecting the concept nodes in the concept map. However, conventional methods of creating concept maps are not able to accurately capture information regarding which candidate concepts should form nodes in the concept map, the edges connecting these nodes, and weights to be assigned to these edges.

### SUMMARY

In an embodiment, a method of creating a concept map for a text corpus is disclosed. The method includes extracting, by a computing device, a plurality of n-grams from the text corpus; creating, by the computing device, a gravity matrix based on a frequency of occurrence of each of the plurality of n-grams within the text corpus and word-distance amongst the plurality of n-grams; calculating, by the computing device, a corpus gravity based on the gravity matrix, the corpus gravity being an aggregate of sum of each row or each column in the gravity matrix; determining, by the computing device, a concept gravity and a concept influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and creating, by the computing device, the concept map based on the concept gravity and the concept influence determined for each of the plurality of n-grams.

In another embodiment, a computing device comprising at least one processor; and a memory communicatively coupled to the at least one processor is disclosed. The memory stores processor instructions, which, on execution, causes the at least one processor to: extract a plurality of n-grams from the text corpus; create a gravity matrix based on a frequency of occurrence of each of the plurality of n-grams within the text corpus and word-distance amongst the plurality of n-grams; calculate a corpus gravity based on the gravity matrix, the corpus gravity being an aggregate of sum of each row or each column in the gravity matrix; determine a concept gravity and a corpus influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and create the concept map based on the concept gravity and the corpus influence determined for each of the plurality of n-grams.

In yet another embodiment, a non-transitory computer-readable storage medium is disclosed. The non-transitory computer-readable storage medium has instructions stored thereon, a set of computer-executable instructions for creating a concept map for a text corpus, causing a computer comprising one or more processors to perform steps comprising; extracting, by a computing device, a plurality of n-grams from the text corpus; creating, by the computing device, a gravity matrix based on frequency of occurrence of each of the plurality of n-grams within the text corpus and word-distance amongst the plurality of n-grams; calculating, by the computing device, a corpus gravity based on the gravity matrix, the corpus gravity being an aggregate of sum of each row or each column in the gravity matrix; determining, by the computing device, a concept gravity and a corpus influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and creating, by the computing device, the concept map based on the concept gravity and the corpus influence determined for each of the plurality of n-grams.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for generating a concept map from a text corpus, in accordance with an embodiment.

FIG. 2 is a block diagram illustrating a computing device that generates the concept map from the text corpus, in accordance with an embodiment.

FIG. 3 illustrates a flow chart of a method for creating a concept map from the text corpus, in accordance with an embodiment.

FIG. 4 illustrates a concept map generated from a text corpus, in accordance with an exemplary embodiment.

FIG. 5 illustrate a flow chart of a method for creating a concept map from the text corpus, in accordance with another embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

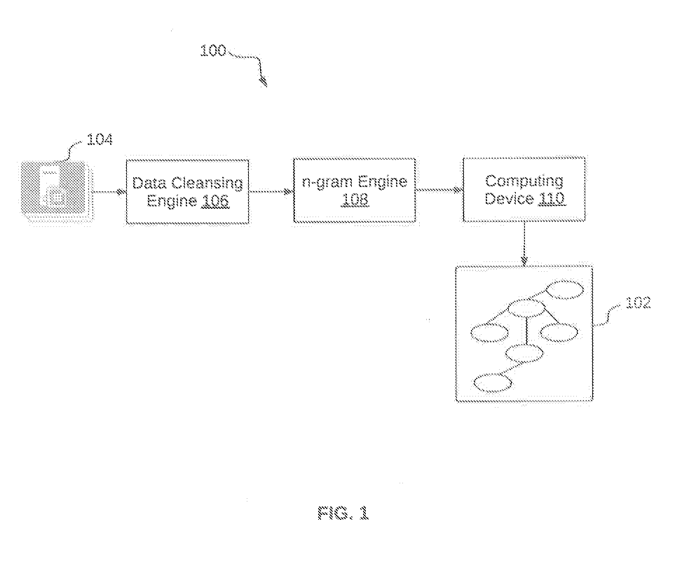

Additional illustrative embodiments are listed below. In one embodiment, a system 100 for generating a concept map 102 from a text corpus 104 is illustrated in FIG. 1. Concept map 102, which is a weighted graph, is generated from text corpus 104 and represents importance of every word or concept present in text corpus 104. Concept map 102 also indicates the strength of connections between these words or concepts. Examples of text corpus 104 may include, but are not limited to Word files, PDF files, transcript of an audio files, or transcript of a video file. Thus, concept map 102 may be generated for an audio or a video file as well. In this case, concept map 102 would represent importance of every word or concept used in the audio or video files.

To generate concept map 102, text corpus 104 is first fed into a data cleansing engine 108 that performs one or more data cleansing operations on text corpus 104. Examples of these data cleansing operations may include, but are not limited to identification of regular expressions, special characters, and well known noise like disclaimers. The data cleansing operations further include performing operations that may include, but are not limited to stemming, spell correction, lemmatization, and removal of stop words (for example, in, on, and, by, all, any, are, do, and for). By way of an example, text corpus 104 may include the sentence: “The deforestation results in lowering of ground water lands and rainfall and water are lost through runoff”, which after performing data cleaning operation may result into: “deforestation result lower ground water land rainfall water lose runoff”. By way of another example, text corpus 104 may include the sentence: “Forests are also necessary to check the floods and soil erosion, and are important for human recreation, wildlife, air and water sheds,” which after performing data cleansing operation may result into: “forest necessary check flood soil erosion important human recreation wildlife air water shed.”

Once text corpus 104 has been cleansed, an n-gram engine 108 splits text corpus 104 into a plurality of n-grams, where n is the number of words in the n-gram. For example, a bi-gram would include two words, a tri-gram would include three words, and a four-gram would include four words. By way of an example, text corpus 104 may include the sentence “plants provide habitat to different types of organisms,” and a plurality of tri-grams are created for this sentence. The plurality of tri-grams would include: “plants provide habitat,” “provide habitat to,” “habitat to different,” “to different types,” “different types of,” “types of organisms.”

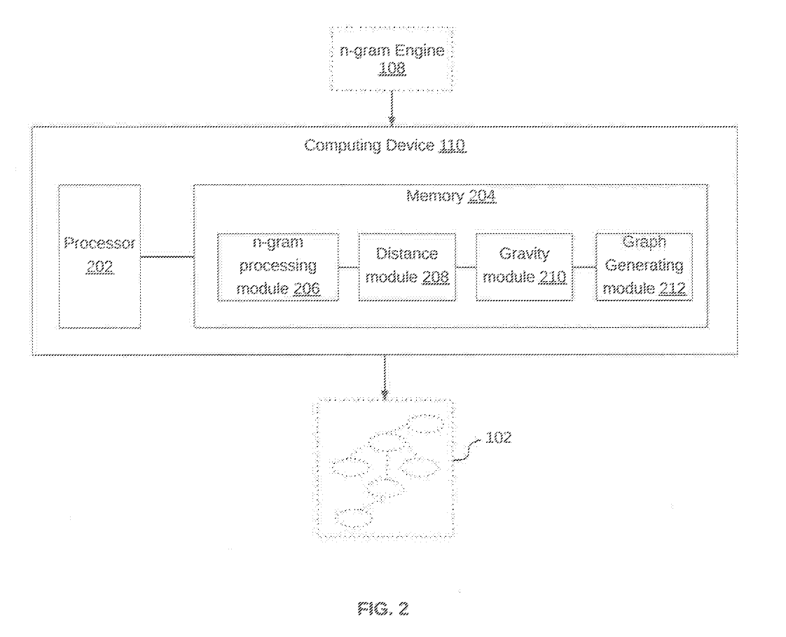

In an embodiment, the type of n-gram that is used to create concept map 102 may depend on complexity associated with text corpus 104. In another embodiment, the type of n-gram that is selected may depend upon a particular domain that text corpus 104 is related to. A predefined mapping of such domains to type of n-grams may be created and stored in system 100 in this case. The plurality of n-grams generated by n-gram engine 108 are then used by computing device 110 to generate concept map 102. Computing device 110 is further explained in detail in conjunction with FIG. 2.

Referring now to FIG. 2, a block diagram of computing device 110 that generates concept map 102 from text corpus 104 is illustrated, in accordance with an embodiment. Computing device 110 includes a processor 202 and a memory 204 that is communicatively coupled to processor 202. Memory 204 includes various modules that store processor instructions, which, on execution, causes processor 202 to generate concept map 102.

Memory 204 includes a n-gram processing module 208, a distance module 208, a gravity module 210, and a graph generating module 212, The plurality of n-grams is received and processed by n-gram processing module 208. N-gram processing module 206 includes information regarding the type of n-gram associated with the plurality of n-grams generated by n-gram engine 108. In other words, n-gram processing module 208 would determine whether n-grams received from n-gram engine 108 are bi-grams, tri-grams, or four-grams, for example. Based on this, n-gram processing module 208 determines the frequency of occurrence of each of the plurality of n-grams within text corpus 104. The frequency of occurrence of an n-gram in text corpus 104 is directly proportional to its gravity or importance in text corpus 104.

Thereafter, distance module 208 computes one or more word-distances between two n-grams selected from the plurality of n-grams. In other words, distance between each occurrence of these two n-grams is computed. This distance computation is repeated for each n-gram in the plurality of n-grams with respect to every other n-gram in the plurality of n-grams. The distance between occurrence of two n-grams is inversely proportional to their influence on each other.

Distance module 208 computes these distances in two directions. In the first direction, distance between occurrence of the first n-gram followed by subsequent occurrence of the second n-gram is computed. In the second direction, distance between occurrence of the second n-gram followed by subsequent occurrence of the first n-gram is computed. It will be apparent to a person skilled in the art that multiple such distances in both directions would be computed for every occurrence of these two n-grams in text corpus 104. After the one or more word-distances between the two n-grams has been computed, an average of the one or more word-distances is calculated for both the directions. These distances are indicative of the degree to which each of these plurality of n-grams affect each other.

By way of an example, distance module 208 computes distance between two tri-grams in text corpus 104, i.e., “plants provide habitat,” and “types of organisms.” Distance module 204 first computes multiple word-distances between every occurrence of “plants provide habitat” followed by “types of organisms.” This is followed by calculation of an average of these multiple word-distances to determine average word-distance between “plants provide habitat” and “types of organisms.” Thereafter, distance module 204 computes multiple word-distances between every occurrence of “types of organisms” followed by “plants provide habitat.” This is followed by calculation of an average of these multiple word-distances to determine average word-distance between “types of organisms” and “plants provide habitat.”

Based on frequency of occurrence of each of the plurality of n-grams and average word-distance amongst the plurality of n-grams computed by distance module 208, gravity module 210 creates a gravity matrix and thereafter calculates a corpus gravity based on the gravity matrix. The corpus gravity is an aggregate of sum of each row or each column in the gravity matrix. Gravity module 210 then determines a concept gravity and a corpus influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix.

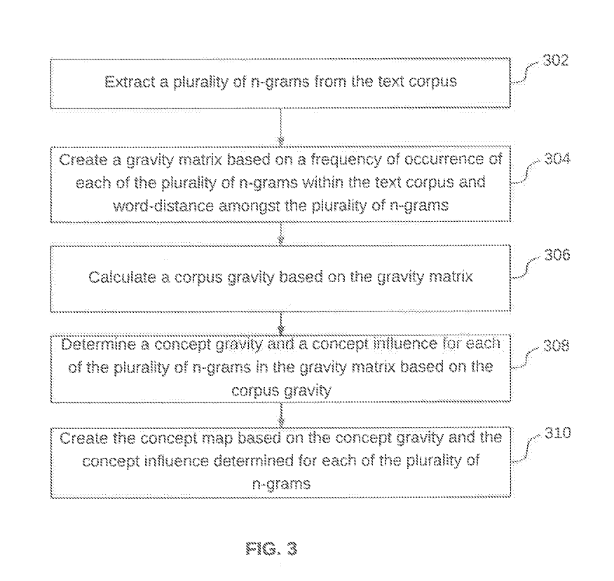

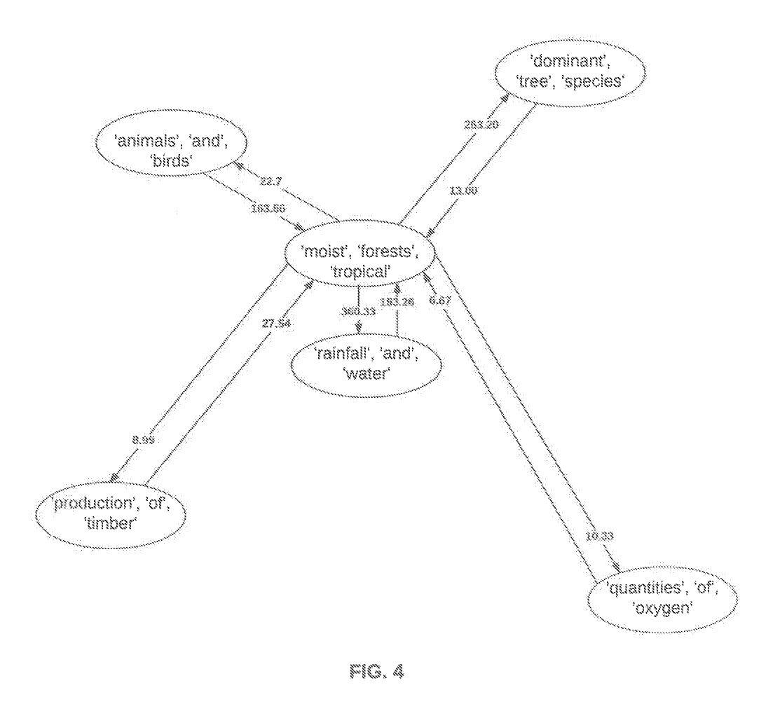

A concept gravity for an n-gram in the gravity matrix is determined based on the corpus gravity and a row aggregate associated with the n-gram in the gravity matrix and a corpus influence for an n-gram in the gravity matrix. This is further explained in detail in conjunction with FIGS. 3 and 4.

Thereafter, graph generating module 212 creates the concept map based on the concept gravity and the corpus influence determined for each of the plurality of n-grams. In other words, graph generating module 212 determines a rank for elements in the gravity matrix based on their importance in the whole text corpus. This rank is then used to sort elements in the gravity matrix and accordingly create the concept map. The concept map ascertains gravity of a given n-gram in the whole text corpus.

FIG. 3 illustrates a flow chart of a method for creating a concept map from the text corpus, in accordance with an embodiment. Before the text corpus is processed to create the concept map, a plurality of data cleansing operations is performed on the text corpus. Examples of these data cleansing operations may include, but are not limited to identification of regular expressions, special characters, and well known noise like disclaimers. The data cleansing operations further include performing operations that may include, but are not limited to stemming, spell correction, and lemmatization.

At 302, a computing device extracts a plurality of n-grams from the text corpus, where n is the number of words in an n-gram. For example, a bi-gram would include two words, a tri-gram would include three words, and a four-gram would include four words. By way of an example, following tri-grams or concepts are extracted from a Word file (text corpus): (‘production’, ‘of,’ ‘timber’); (‘moist’, ‘forests’, ‘tropical’); (‘dominant’, ‘tree’, ‘species’); (‘rainfall’, ‘and’, ‘water’); (‘quantities’, ‘of’, ‘oxygen’); (‘animals’, ‘and’, ‘birds’).

Thereafter, frequency of occurrence of each of these plurality of n-grams within the text corpus is determined. In continuation of the example above, the frequency of occurrence for the tri-grams may be depicted by table 1 given below:

TABLE 1

| Tri-gram/Concept | Frequency |
|---|---|
| ‘production’, ‘of’, ‘timber’ | 120 |
| ‘moist’, ‘forests’, ‘tropical’ | 235 |
| ‘dominant’, ‘tree’, ‘species’ | 112 |
| ‘rainfall’, ‘and’, ‘water’ | 345 |
| ‘quantities’, ‘of’, ‘oxygen’ | 89 |
| ‘animals’, ‘and’, ‘birds’ | 435 |

Thereafter, the one or more word-distances between multiple set of two n-grams selected from the plurality of n-grams is computed. In other words, distance between each subsequent occurrence of these two n-grams is computed. This distance computation is repeated for each n-gram in the plurality of n-grams with respect to every other n-gram in the plurality of n-grams.

One or more first word-distances in the one or more word-distances is equal to number of words between occurrence of a first n-gram of the two n-grams followed by occurrence of a second n-gram of the two n-grams. Similarly, a second word-distance of the one or more word-distances is equal to number of words between occurrence of the second n-gram followed by occurrence of the first n-gram. In other words, these distances are computed in two directions. In the first direction, distance between occurrence of the first n-gram followed by subsequent occurrence of the second n-gram is computed. In the second direction, distance between occurrence of the second n-gram followed by subsequent occurrence of the first n-gram is computed.

After the one or more word-distances between the two n-grams has been computed, an average of the one or more word-distances is calculated for both the directions. It will be apparent to a person skilled in the art that multiple such distances in both directions and their average would be computed for every occurrence of these two n-grams in the text corpus. These average distances are indicative of the degree to which each of these plurality of n-grams affect each other. In continuation of the example above, average word distance amongst these tri-grams may be represented by an average distance matrix table 2 given below:

TABLE 2

| | ‘production’, | ‘moist’, | ‘dominant’, | ‘rainfall’, | ‘quantities’, | ‘animals’, |
|---|---|---|---|---|---|---|
| | ‘of’, | ‘forests’, | ‘tree’, | ‘and’, | ‘of’, | ‘and’, |
| Tri-gram/Concept | ‘timber’ | ‘tropical’ | ‘species’ | ‘water’ | ‘oxygen’ | ‘birds’ |
| ‘production’, ‘of’, ‘timber’ | 0 | 32 | 12 | 38 | 59 | 112 |
| ‘moist’, ‘forests’, ‘tropical’ | 56 | 0 | 10 | 15 | 45 | 67 |
| ‘dominant’, ‘tree’, ‘species’ | 24 | 45 | 0 | 18 | 35 | 24 |
| ‘rainfall’, ‘and’, ‘water’ | 45 | 23 | 38 | 0 | 12 | 45 |
| ‘quantities’, ‘of’, ‘oxygen’ | 35 | 56 | 28 | 27 | 0 | 73 |
| ‘animals’, ‘and’, ‘birds’ | 45 | 25 | 30 | 45 | 56 | 0 |

Thus, based on table 2 above, the average word-distances between the two trigrams: (‘production’, ‘of’, ‘timber,’) and (‘moist’, ‘forests’, ‘tropical’) is 32 and 58 in both directions. The average word-distance of 32 is between an occurrence of the tri-gram: (‘production’, ‘of’, ‘timber,’) followed by occurrence of the tri-gram: (‘moist’, ‘forests’, ‘tropical’). The average word-distance of 58 is between an occurrence of the tri-gram: (‘moist’, ‘forests’, ‘tropical’) followed by occurrence of the tri-gram: (‘production’, ‘of’, ‘timber,’). Similarly, such distance between each tri-gram with every other trigram in both directions within the text corpus is depicted in table 2.

Based on a frequency of occurrence of each of the plurality of n-grams within the text corpus and one or more word-distances amongst the plurality of n-grams, a gravity matrix is created at 304. Value of an element in the gravity matrix corresponding to intersection of any two n-grams is computed based on a frequency of occurrence of each of the two n-grams and one of the one or more word-distances between those two n-grams. In an embodiment, value of an element in the gravity matrix may be computed using equation 1 given below:

$${G}_{ij} = \frac{{f}_{i} {f}_{j}}{{d}_{ij}^{2}} \qquad ( 1 )$$

where,
i represents the first n-gram in the two n-grams;
j represents the second n-gram in the two n-grams;
Gᵢⱼ is the value of an element in the gravity matrix corresponding to intersection of the i^{th} and j^{th} n-gram;
fᵢ is the frequency of occurrence of the i^{th} n-gram in the text corpus;
fⱼ is the frequency of occurrence of the j^{th} n-gram in the text corpus;
dᵢⱼ is the average word-distance between occurrence of i^{th} n-gram followed by subsequent occurrence of j^{th} n-gram in the text corpus.
For example, dᵢⱼ between occurrence of (‘production’, ‘of’, ‘timber,’) followed by subsequent occurrence of (‘moist’, ‘forests’, ‘tropical’) is 32 as given in table 2.

In continuation of the example above, the gravity matrix may be represented by table 3 given below:

TABLE 3

| | ‘production’, | ‘moist’, | ‘dominant’, | ‘rainfall’, | ‘quantities’, | ‘animals’, | |
|---|---|---|---|---|---|---|---|
| | ‘of’, | ‘forests’, | ‘tree’, | ‘and’, | ‘of’, | ‘and’, | Row |
| Gravity Matrix | ‘timber’ | ‘tropical’ | ‘species’ | ‘water’ | ‘oxygen’ | ‘birds’ | Sum |
| ‘production’, ‘of’, ‘timber’ | 1.00 | 27.54 | 93.33 | 28.67 | 3.07 | 4.16 | 157.77 |
| ‘moist’, ‘forests’, ‘tropical’ | 8.99 | 1.00 | 263.20 | 360.33 | 10.33 | 22.77 | 666.63 |
| ‘dominant’, ‘tree’, ‘species’ | 23.33 | 13.00 | 1.00 | 119.26 | 8.14 | 84.58 | 249.31 |
| ‘rainfall’, ‘and’, ‘water’ | 20.44 | 153.28 | 26.76 | 1.00 | 213.23 | 74.11 | 488.80 |
| ‘quantities’, ‘of’, ‘oxygen’ | 8.72 | 6.67 | 12.71 | 42.12 | 1.00 | 7.26 | 78.49 |
| ‘animals’, ‘and’, ‘birds’ | 25.78 | 163.56 | 54.13 | 74.11 | 12.35 | 1.00 | 330.93 |
| Column Sum | 88.27 | 365.03 | 451.14 | 625.49 | 248.11 | 193.89 | 1972 |

In the gravity matrix given in table 3 above, for illustrative purpose, we consider two elements in the gravity matrix that are at intersection of the two tri-grams: (‘production’, ‘of’, ‘timber,’) and (‘moist’, ‘forests’, ‘tropical’). The first element corresponds to occurrence of (‘production’, ‘of’, ‘timber,’) followed by subsequent occurrence of (‘moist’, ‘forests’, ‘tropical.’) In this case, the value for the first element is computed using frequency values given in table 1 and average distance values given in table 2. The value is computed using the equation 1 as: [(120)*(235)]/(32)2=27.54. Similarly, the value for the second element that corresponds to occurrence of (‘moist’, ‘forests’, ‘tropical’) followed by subsequent occurrence of (‘production’, ‘of’, ‘timber,’) is computed using the equation 1 as: [(235)*(120)]/(56)²=8.99.

At 306, a corpus gravity is calculated based on the gravity matrix. The corpus gravity is an aggregate of sum of each row in the gravity matrix. The corpus gravity is also an aggregate of sum of each column in the gravity matrix. Once the gravity matrix has been created, sum of each column and each row in the gravity matrix is first computed. This is followed by computing a column aggregate for these column sums and a row aggregate for these row sums.

By way of an example and with reference to table 3, a total sum of the values in each column and each row is computed and depicted in table 3. For example, for the column associated with (‘production’, ‘of’, ‘timber,’) the column sum is 88.27 and for the row associated with (‘production’, ‘of’, ‘timber,’) the row sum is 157.77. Similarly, sums computed for each row and each column are given in gravity matrix of table 3. To compute the corpus gravity of the gravity matrix in table 3, an aggregate of the sums computed for each column is calculated as: 1972. Similarly, an aggregate of the sums computed for each row is also calculated as: 1972. In other words, the corpus gravity for the gravity matrix given in table 3 is 1972.

Thereafter, using the corpus gravity, the computing device, at 308, determines a concept gravity and a corpus influence for each of the plurality of n-grams in the gravity matrix. A concept gravity for an n-gram in the gravity matrix is determined based on the corpus gravity and a row sum associated with the n-gram in the gravity matrix. A concept gravity for an n-gram may be computed using the equation 2 given below:

$$\frac{\sum r\_i}{CG} \qquad ( 2 )$$

where,
Σr_i is the row sum associated with an n-gram;
CG is the corpus gravity.

By way of an example and referring to gravity matrix given in table 3, concept gravity for the tri-gram: (‘production’, ‘of’, ‘timber,’) may be computed using equation 2 as: [(157.77)/1972]=0.08, where, ‘157.77’ is the row sum, ‘1972’ is the corpus gravity, and ‘0.08’ is the concept gravity.

Similarly, a corpus influence for an n-gram in the gravity matrix is determined based on the corpus gravity and a column aggregate associated with the n-gram in the gravity matrix. A corpus influence for an n-gram may be computed using the equation 3 given below:

$$\frac{\sum c\_i}{CG} \qquad ( 3 )$$

where,
Σc_i is the column sum associated with an n-gram;
CG is the corpus gravity.

By way of an example and referring to gravity matrix given in table 3, corpus influence for the tri-gram: (‘production’, ‘of’, ‘timber,’) may be computed using equation 3 as: [(88.27)/1972]=0.04, where, ‘88.27’ is the column sum, ‘1972’ is the corpus gravity, and ‘0.04’ is the corpus influence. When concept gravity and corpus influence is computed for each tri-gram given in gravity matrix of table 3, these values may be represented by table 4 given below:

TABLE 4

| | Concept | Corpus |
|---|---|---|
| | Gravity | Influence |
| Tri-gram/Concept | (Rows) | (Columns) |
| ‘production’, ‘of’, | 0.08 | 0.04 |
| ‘timber’ | | |
| ‘moist’, ‘forests’, | 0.34 | 0.19 |
| ‘tropical’ | | |
| ‘dominant’, ‘tree’, | 0.13 | 0.23 |
| ‘species’ | | |
| ‘rainfall’, ‘and’, | 0.25 | 0.32 |
| ‘water’ | | |
| ‘quantities’, ‘of’, | 0.04 | 0.13 |
| ‘oxygen’ | | |
| ‘animals’, ‘and’, | 0.17 | 0.10 |
| ‘birds’ | | |

Based on the gravity matrix and the concept gravity and the corpus influence determined for each of the plurality of n-grams, the computing device creates the concept map at 310. In an embodiment of the invention, the nodes of the concept map are the n-grams/concepts in the gravity matrix. The value of elements in the gravity matrix computed using the equation:

$$( {G}_{ij} = \frac{{f}_{i} {f}_{j}}{{d}_{ij}^{2}} )$$

would represent the edge weight between the edges of the nodes in the concept graph. Moreover, the nodes in the concept map that have higher value of concept gravity are drawn closer to the center of the concept map, whereas the nodes that have lower concept gravity are drawn farther away from the center of the concept map. The value of corpus influence is used to break any ties that may occur between the values of concept gravity. The nodes in the concept map that have higher value of corpus influence would be farther away from the center of the concept map.

An exemplary concept map 400 created based on the gravity matrix given in table 2 and concept gravity and corporate influence given in table 4 is illustrated in FIG. 4, in an exemplary embodiment. In concept map 400, as the node: (‘moist’, ‘forests’, ‘tropical’) has highest concept gravity, i.e., 0.34, it is located at the center of concept map 400 and as the node: (‘quantities’, ‘of’, ‘oxygen’) has the lowest concept gravity, i.e., 0.04, it is located farthermost from the center of concept map 500. The location of a node in concept map 500 identifies the importance or prominence of the concept/trigram (represented as the node) for understanding the text corpus.

The numbers mentioned on the edges connecting two nodes represent the weight of that edge and are retrieved from the gravity matrix given in table 3. For example, weight of the edge that connects the node: (‘moist’, ‘forests’, ‘tropical’) with the node: (‘quantities’, ‘of’, ‘oxygen’) is 10.33 and weight of the edge that connects the node: (‘quantities’, ‘of’, ‘oxygen’) with the node: (‘moist’, ‘forests’, ‘tropical’) is 6.67. The weights assigned to the edges between two nodes determine the magnitude of the strength of association in either direction between the tri-grams represented by these nodes. By way of an example, in concept map 400, strongest association is between occurrence of (‘moist’, ‘forests’, ‘tropical’) followed by occurrence of (‘rainfall’, ‘and’, ‘water’) as, the weight of edge connecting the node for (‘moist’, ‘forests’, ‘tropical’) to the node for (‘rainfall’, ‘and’, ‘water’) is 380.33. By way of another example, amongst the edges connecting the node for (‘moist’, ‘forests’, ‘tropical’) to other nodes in concept map 400, the edge connecting with the node for (‘production’, ‘of’, ‘timber’) has the lowest weight, i.e., 8.99. In other words, occurrence of (‘moist’, ‘forests’, ‘tropical’) followed by occurrence of (‘production’, ‘of’, ‘timber’) has the weakest association, in term of the tri-gram: (‘moist’, ‘forests’, ‘tropical:’)

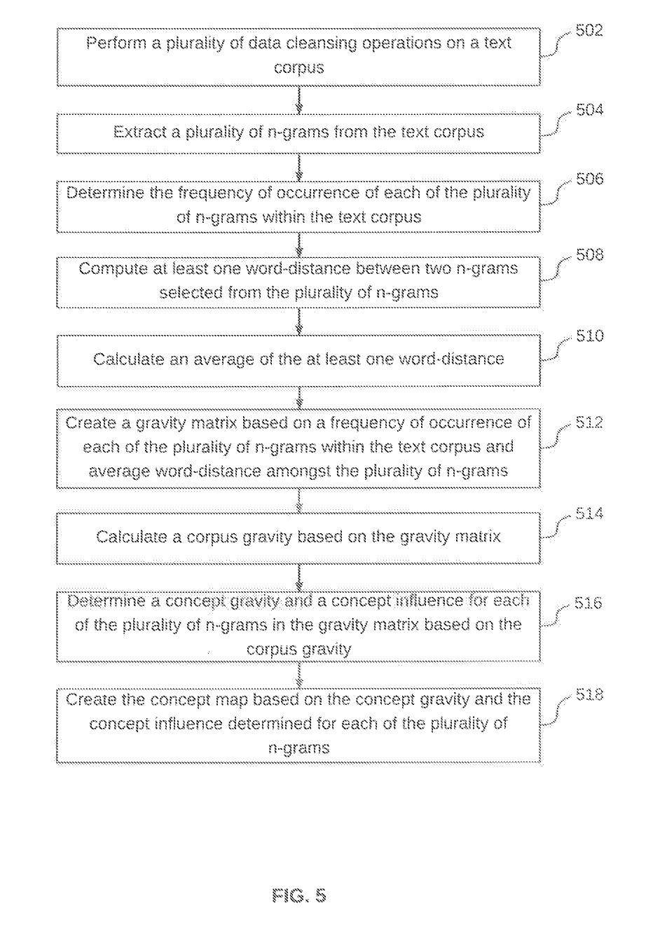

FIG. 5 illustrates a flow chart of a method for creating a concept map from the text corpus, in accordance with another embodiment. Before the text corpus is processed to create the concept map, a plurality of data cleansing operations is performed on the text corpus at 502. Examples of these data cleansing operations may include, but are not limited to identification of regular expressions, special characters, and well known noise like disclaimers. The data cleansing operations further include performing operations that may include, but are not limited to stemming, spell correction, and lemmatization.

At 504, a plurality of n-grams is extracted from the text corpus, where n is the number of words in an n-gram. For example, a bi-gram would include two words, a tri-gram would include three words, and a four-gram would include four words. By way of an example, following tri-grams or concepts are extracted from a Word file (text corpus): (‘production’, ‘of’, ‘timber’); (‘moist’, ‘forests’, ‘tropical’); (‘dominant’, ‘tree’, ‘species’); (‘rainfall’, ‘and’, ‘water’); (‘quantities’, ‘of’, ‘oxygen’); (‘animals’, ‘and’, ‘birds.’)

Thereafter, at 508, frequency of occurrence of each of these plurality of n-grams within the text corpus is determined. At 508, the one or more word-distances between multiple set of two n-grams selected from the plurality of n-grams is computed. In other words, distance between each subsequent occurrence of these two n-grams is computed. This distance computation is repeated for each n-gram in the plurality of n-grams with respect to every other n-gram in the plurality of n-grams. Thereafter, at 510, an average of the one or more word-distances is calculated for both the directions. It will be apparent to a person skilled in the art that multiple such distances in both directions and their average would be computed for every occurrence of these two n-grams in the text corpus. These average distances are indicative of the degree to which each of these plurality of n-grams affect each other. This has been explained in detail in conjunction with FIG. 3.

Based on a frequency of occurrence of each of the plurality of n-grams within the text corpus and one or more word-distances amongst the plurality of n-grams, a gravity matrix is created at 512. A corpus gravity is then calculated based on the gravity matrix at 514. The corpus gravity is an aggregate of sum of each row in the gravity matrix. The corpus gravity is also an aggregate of sum of each column in the gravity matrix. Thereafter, using the corpus gravity, a concept gravity and a corpus influence is determined for each of the plurality of n-grams in the gravity matrix at 516. Based on the gravity matrix and the concept gravity and the corpus influence determined for each of the plurality of n-grams, the concept map is created at 518. In an embodiment of the invention, the nodes of the concept map are the n-grams/concepts in the gravity matrix. This has been explained in detail in conjunction with FIG. 3.

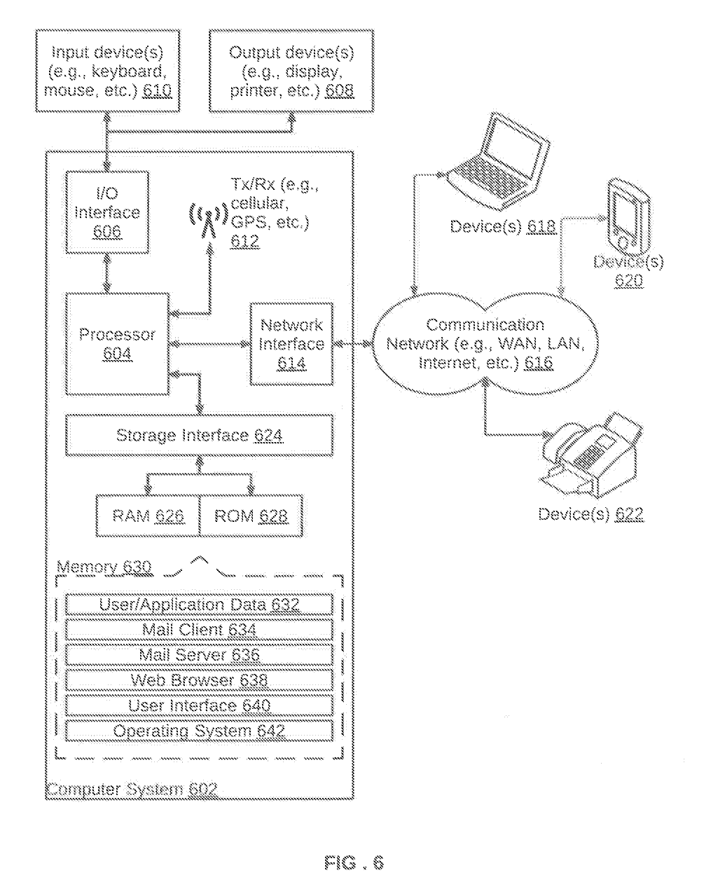

Referring now to FIG. 6, a block diagram of an exemplary computer system 602 for implementing various embodiments is illustrated. Computer system 602 may comprise a central processing unit (“CPU” or “processor”) 604. Processor 604 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. Processor 804 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 610 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 608 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (e.g., Texas Instruments WiLink WL1283, Broadcom BCM4750IUB8, Infineon Technologies X-Gold 818-PMB9800, or the like), providing IEEE 802.11a/b/g/n, Bluetooth, FM, global positioning system (GPS), 2G/3G HSDPA/HSUPA communications, etc.

In some embodiments, processor 604 may be disposed in communication with a communication network 616 via a network interface 614. Network interface 614 may communicate with communication network 616. Network interface 614 may employ connection protocols including, without limitation, direct connect, Ethernet (e.g., twisted pair 10/100/1000 Base T), transmission control protocol/internet protocol (TCP/IP), token ring, IEEE 802.11a/b/g/rs/x, etc. Communication network 616 may include, without limitation, a direct interconnection, local area network (LAN), wide area network (WAN), wireless network (e.g., using Wireless Application Protocol), the Internet, etc. Using network interface 614 and communication network 616, computer system 602 may communicate with devices 618, 620, and 622. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS( Sony PlayStation, etc.), or the like. In some embodiments, computer system 602 may itself embody one or more of these devices.

In some embodiments, processor 604 may be disposed in communication with one or more memory devices (e.g., RAM 626, ROM 628, etc.) via a storage interface 624. Storage interface 624 may connect to memory devices 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 630 may store a collection of program or database components, including, without limitation, an operating system 642, a user interface 640, a web browser 638, a mail server 636, a mail client 634, a user/application data 632 (e.g., any data variables or data records discussed in this disclosure), etc. Operating system 642 may facilitate resource management and operation of the computer system 602. Examples of operating system 642 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 640 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 602 may implement web browser 638 stored program component. Web browser 638 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 602 may implement mail server 636 stored program component. Mail server 636 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement mail client 634 stored program component. Mail client 634 may be a mail viewing application, such as Apple Mail, Microsoft Entourage, Microsoft Outlook, Mozilla Thunderbird, etc.

In some embodiments, computer system 602 may store user/application data 632, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc,). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provide systems and methods for creating concept maps using concept gravity matrix. The methodology proposed determines distance amongst n-grams in two directions, which allows designing an ingenuous process of building a gravity matrix to assess the magnitude of strength of relationship between n-grams. The method of creating concept maps using concept gravity and corpus influence leading to their actual physical placement in a concept map helps in identifying words/concepts that are prominent for the understanding of the text. The concept maps also determine the strength of association between concepts/words.

The specification has described systems and methods for creating concept maps using concept gravity matrix. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of creating a concept map for a text corpus, the method comprising:
extracting, by a computing device, a plurality of n-grams from the text corpus;
creating, by the computing device, a gravity matrix based on a frequency of occurrence of each of the plurality of n-grams within the text corpus and word-distance amongst the plurality of n-grams;
calculating, by the computing device, a corpus gravity based on the gravity matrix, the corpus gravity being an aggregate of sum of each row or each column in the gravity matrix;
determining, by the computing device, a concept gravity and a concept influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and
creating, by the computing device, the concept map based on the concept gravity and the concept influence determined for each of the plurality of n-grams.

2. The method of claim 1 further comprising determining the frequency of occurrence of each of the plurality of n-grams within the text corpus.

3. The method of claim 1 further comprising computing at least one word-distance between two n-grams selected from the plurality of n-grams.

4. The method of claim 3, wherein a first word-distance of the at least one word-distance is equal to number of words between occurrence of a first n-gram of the two n-grams followed by occurrence of a second n-gram of the two n-grams.

5. The method of claim 4, wherein a second word-distance of the at least one word-distance is equal to number of words between occurrence of the second n-gram followed by occurrence of the first n-gram.

6. The method of claim 3, wherein value of an element in the gravity matrix corresponding to intersection of the two n-grams is computed based on a frequency of occurrence of each of the two n-grams and one of the at least one word-distance between two n-grams.

7. The method of claim 1 further comprising performing a plurality of data cleansing operations on the text corpus, the plurality of n-grams being extracted subsequent to performing the plurality of data cleansing operations.

8. The method of claim 1, wherein the gravity matrix comprises a subset of the plurality of n-grams, frequency of occurrence of each n-gram in the subset being greater than a predefined frequency of occurrence.

9. The method of claim 1, wherein a concept gravity for an n-gram in the gravity matrix is determined based on the corpus gravity and a row sum associated with the n-gram in the gravity matrix.

10. The method of claim 1, wherein a corpus influence for an n-gram in the gravity matrix is determined based on the corpus gravity and a column sum associated with the n-gram in the gravity matrix.

11. A computing device comprising:
at least one processor; and
a memory communicatively coupled to the at least one processor, wherein the memory stores processor instructions, which, on execution, causes the at least one processor to:
extract a plurality of n-grams from the text corpus;
create a gravity matrix based on a frequency of occurrence of each of the plurality of n-grams within the text corpus and word-distance amongst the plurality of n-grams;
calculate a corpus gravity based on the gravity matrix, the corpus gravity being an aggregate of sum of each row or each column in the gravity matrix;
determine a concept gravity and a corpus influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and
create the concept map based on the concept gravity and the corpus influence determined for each of the plurality of n-grams.

12. The computing device of claim 1, wherein the at least one processor is further configured to determine the frequency of occurrence of each of the plurality of n-grams within the text corpus.

13. The computing device of claim 1, wherein the at least one processor is further configured to compute at least one word-distance between two n-grams selected from the plurality of n-grams.

14. The computing device of claim 13, wherein a first word-distance of the at least one word-distance is equal to number of words between occurrence of a first n-gram of the two n-grams followed by occurrence of a second n-gram of the two n-grams.

15. The computing device of claim 14, wherein a second word-distance of the at least one word-distance is equal to number of words between occurrence of the second n-gram followed by occurrence of the first n-gram.

16. The computing device of claim 13, wherein value of an element in the gravity matrix corresponding to intersection of the two n-grams is computed based on a frequency of occurrence of each of the two n-grams and one of the at least one word-distance between two n-grams.

17. The computing device of claim 11, wherein the gravity matrix comprises a subset of the plurality of n-grams, frequency of occurrence of each n-gram in the subset being greater than a predefined frequency of occurrence.

18. The computing device of claim 1, wherein a concept gravity for an n-gram in the gravity matrix is determined based on the corpus gravity and a row aggregate associated with the n-gram in the gravity matrix.

19. The computing device of claim 1, wherein a corpus influence for an n-gram in the gravity matrix is determined based on the corpus gravity and a column aggregate associated with the n-gram in the gravity matrix.

20. A non-transitory computer-readable storage medium having stored thereon, a set of computer-executable instructions for creating a concept map for a text corpus, causing a computer comprising one or more processors to perform steps comprising:
extracting, by a computing device, a plurality of n-grams from the text corpus;
creating, by the computing device, a gravity matrix based on frequency of occurrence of each of the plurality of n-grams within the text corpus and word-distance amongst the plurality of n-grams;
calculating, by the computing device, a corpus gravity based on the gravity matrix, the corpus gravity being an aggregate of sum of each row or each column in the gravity matrix;
determining, by the computing device, a concept gravity and a corpus influence for each of the plurality of n-grams in the gravity matrix based on the corpus gravity, a row aggregate associated with each of the plurality of n-grams in the gravity matrix, and a column aggregate associated with each of the plurality of n-grams in the gravity matrix; and
creating, by the computing device, the concept map based on the concept gravity and the corpus influence determined for each of the plurality of n-grams.
